(19) United States
(12) Patent Application Publication
(10) Pub. No.: US 2014/0262077 A1
(43) Pub. Date: Sep. 18, 2014

(54) COMPACT POWER ACTUATOR FOR WINDOW SHADES

(71) Applicant: Comfortex Window Fashions, Maplewood, NY (US)

(72) Inventor: Richard Watkins, Lake Luzerne, NY (US)

(21) Appl. No.: 13/915,713

(22) Filed: Jun. 12, 2013

Related U.S. Application Data
(60) Provisional application No. 61/791,733, filed on Mar. 15, 2013.

(51) Int. Cl. E06B 9/68; E06B 9/40

(52) U.S. Cl. CPC E06B 9/68; E06B 9/40
USPC 160/310

(57) ABSTRACT

A window shade having a power actuation system. The window shade includes a fixed member; a rotatable member that is rotatable relative to the fixed member; a reversible motor mounted to the fixed member, wherein the reversible motor includes a mechanism for driving the rotatable member such that rotation of the reversible motor in a first direction deploys a shade material and rotation of the reversible motor in a second direction stows the shade material; and a control circuit coupled to a set of motor leads of the reversible motor, wherein the control circuit switches the reversible motor among at least three operational states, including: a hold state in which the motor leads are shorted to resist rotation, a deploy state in which the motor leads are connected to a power source to deploy the shade material, and a stow state in which the motor leads are connected in reverse to the power source to stow the shade material.

### PRIORITY CLAIM

This application claims priority to co-pending provisional application Ser. No. 61/791,733, filed Mar. 15, 2013, entitled “Low-cost Power Actuator for Window Shades,” the content of which is hereby incorporated by reference.

### BACKGROUND

The present invention relates to window shades, and more particularly to a power actuator for raising and lowering window shades.

Most window shades (e.g., roller, cellular, pleated, fabric-venetian, etc.) are operated by a cord system, e.g., either a cord lock with a pull cord through the shade, or a loop cord through a clutch and roller at the top of the shade. In particular, fabric venetians (sometimes called ‘window shadings’) such as the Shangri-La™ by COMFORTEX or Silhouette™ by HUNTER DOUGLAS (specialty roller shades with multi-layered fabric that includes inner tiltable fabric vanes) require the loop-cord and clutch system to perform the final roll rotation that actuates the tiltable vanes once the shade has reached full extension. Such clutch systems must be fitted to the end of the roller, outboard of the fabric width, which leaves an unsightly and undesirable gap between fabric edge and window opening. This issue is especially problematic in opaque, light-blocking shade styles.

There is a strong demand for window shade actuation systems that do not include any accessible cords or cord loops. Many alternative systems have been proposed, but most are significantly more expensive than existing actuators. Motorization of shade actuation may be seen as such a solution, eliminating all cords and providing additional benefits like remote control or timer-driven deployment. Prominent suppliers of such motorization (for example, SOMFY or HARMONIC DESIGNS) offer such systems that are intended to fit in place of the manual clutch and cord loop most commonly used on large (more costly) shades. The cost of these motors is often as much as that of the shade itself and so use of these systems has been restricted to only the most expensive of applications. Further, because the systems fit where clutches would otherwise go, they do not improve the side gap characteristic of the clutch systems.

A simplified motorization system for shades on rollers, with cost near to that of manual clutch systems, with easy installation and unobtrusive appearance, with reliable ease of use, and with reduced requirement for side-gap between shade and window opening is desired.

### BRIEF SUMMARY

Disclosed is a cordless and effortless actuator for window shades that brings the safety of cordless operation and the advantages of motorized operation to shades.

According to one embodiment of the present invention, an actuation system for a window shade is disclosed comprising: a reversible motor mounted to a fixed member of the window shade, wherein the reversible motor includes a mechanism for driving a rotatable member of the window shade such that rotation of the reversible motor in a first direction deploys a shade material and rotation of the reversible motor in a second direction stows the shade material; and a control circuit coupled to a set of motor leads of the reversible motor, wherein the control circuit switches the reversible motor among at least three operational states, including: a hold state in which the motor leads are shorted to resist rotation, a deploy state in which the motor leads are connected to a power source to deploy the shade material, and a stow state in which the motor leads are connected in reverse to the power source to stow the shade material.

According to a second embodiment of the present invention, a window shade is disclosed, comprising: a fixed member; a rotatable member that is rotatable relative to the fixed member; a reversible motor mounted to the fixed member, wherein the reversible motor includes a mechanism for driving the rotatable member such that rotation of the reversible motor in a first direction deploys a shade material and rotation of the reversible motor in a second direction stows the shade material; and a control circuit coupled to a set of motor leads of the reversible motor, wherein the control circuit switches the reversible motor among at least three operational states, including: a hold state in which the motor leads are shorted to resist rotation, a deploy state in which the motor leads are connected to a power source to deploy the shade material, and a stow state in which the motor leads are connected in reverse to the power source to stow the shade material.

According to a third embodiment of the present invention, a window shade is disclosed, comprising: a shade material; and an actuation system for causing a motor to move the shade material in response to an activation of a momentary switch, wherein the actuation system includes a braking system that holds the shade material in place in response to a deactivation of the momentary switch, wherein the braking system short-circuits the motor to place the motor in a hold position state.

Accordingly, a powered actuation system for window shades is provided that both lowers cost to near that of manual, cord-operated assemblies, but also eliminates the need for much of the side ‘light gap’ between shade edge and window frame (otherwise required for loop cord and clutch systems on roller shades), and eliminates all possibility of accidental injury from entanglement in cords. Economy, performance, and safety are all enhanced.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings.

FIG. 1 depicts an illustrative window shade having a power actuator system in accordance with an embodiment of the present invention.

FIGS. 2A-C depict three different states of an illustrative power actuator system comprising a circuit, motor, and power source, for controlling a window shade in accordance with an embodiment of the present invention.

FIG. 3 depicts an alternative illustrative power actuator system comprising a circuit, motor and power source for controlling a window shade in accordance with an embodiment of the present invention.

FIG. 4 depicts a second alternative illustrative power actuator system comprising a circuit, motor, power source and relays for controlling a window shade in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like reference numbering represents like elements.

### DETAILED DESCRIPTION

Embodiments of the invention are generally drawn to an actuation system for raising and lowering a window shade. FIG. 1 depicts an illustrative embodiment of a window shade 60 having such an actuation system. In this embodiment, the actuation system includes a reversible DC-type electric motor 64 configured to fit inside a rotatable tubular member (i.e., “roller”) 62 commonly used in roll-up type window shades. The motor 64 has only forward, backward, and off states, with no need for electronics. A battery or other source of DC power 68 is provided along with a control circuit 66 that shorts the motor windings when neither up nor down motion of the shade is desired (motor ‘off’ and shade stationary). Accordingly, an end-of-movement determined by release of an operator's touch on a momentary switch (rather than by a pre-programmed all-up or all-down position) is provided, in which the release of the operator's touch short-circuits the motor, placing it in a hold position state.

Short-circuiting the motor 64 provides a braking force opposing any movement of the motor rotor with respect to its stator. With no connected power, any attempt to forcibly rotate the motor 64 essentially causes the motor 64 to operate as a generator. With the motor leads shorted, the generated electricity has nowhere to go, which thus results in a braking force, i.e., a significant resistance against rotation. Thus, if an external force such as gravity tries to rotate the roller 62, a voltage is generated; but with the circuit shorted, no voltage can arise without a near-infinite current flowing through the short. That results in a very strong braking force (the falling shade's power is insufficient to support the current dissipation in the short-circuit).

The braking force is further enhanced by a friction component associated with one or more moving parts of the shade 60, such as that created between roller 62 and collar assembly 74. The friction component helps to avoid the shade material from slowly creeping due to gravity or the like. The two combined resistive forces thus prevent unintended or self-initiated movement of the motor (forward or backward) and shade (up or down).

Operation of the shade 60 is achieved by pressing one of two momentary switches 70 that either directly or via relay, relieves the short-circuit and connects the windings of the motor 64 to the DC power source 68 with appropriate polarity to cause forward or backward rotation and up or down movement of the shade material 64. The switches 70 may be of a membrane type with very low profile and very low cost. Because only the wires 80, 82 connecting the motor 64 to the power source 68 and switches 70 need to exit the end of the roller 62, the gap 90 between the shade 60 (as wide as the roller) and the side of the window opening 86 can be very small (e.g., less than 0.25 inches for typical applications and less than 0.1 inches in more demanding applications), just enough to pass the wires and a small clearance. Gap 90 could even be non-existent if, e.g., the shade configuration allowed wires 80, 82 to exit the shade 60 above where the shade material 64 is deployed.

A representative actuation system 10 incorporating such a control circuit 66 is shown in FIGS. 2A-2C, which depict three different operational states, OFF, UP, and DOWN, respectively. Actuation system 10 includes a motor (M) 12, a power source (B) 14, and two double pole switches 16 and 18. FIG. 2A shows actuation circuit 10 in the OFF or hold state. In the OFF state both switches 16 and 18 are in a first position, which results in the motor 12 being shorted.

FIG. 2B shows actuation system 10 in the UP state. In this state, switch 16 has been activated (i.e., momentarily pressed) causing switch 16 to toggle to a second position. When this occurs, current from the power source 14 is delivered to the motor 12 with a first polarity, which causes the motor 12 to spin in a first direction and, e.g., raise the shade.

FIG. 2C shows actuation system 10 in the DOWN state. In this state, switch 18 has been activated causing the switch 18 to toggle to a second position. When this occurs, current from the power source 14 is delivered to the motor 12 with a second polarity, which causes the motor 12 to spin in a second, opposite direction and, e.g., lower the shade.

Other circuits are possible that achieve the indicated OFF and UP/DOWN connections. For instance, circuit 30 shown in FIG. 3 will achieve the same functionality with a slightly different wiring configuration. FIG. 4 depicts a further circuit 32 that utilizes double pole/double throw switches with relays 20 to activated the associated switches. Relays 20 utilize three lines and a pair of momentary switches 22, 24 that connect the top two or bottom two lines shown in the relay 20. The use of relays may be employed so switches can be less costly in order to implement momentary, normally-open type systems.

Referring again to FIG. 1, power driven roll-up shade 60 is described in further detail. For brevity purposes, a cut-away illustration is provided in which only one end of the shade 60 is shown. Shade 60 generally includes a rotatable member 62, e.g., a rotatable tubular member or roller, having a shade material 64 attached thereto. Rotatable member 62 is configured to rotate in both directions to deploy and stow shade material 64 as desired by an end user.

Positioned within rotatable tubular member 62 is a fixed member 63, e.g., fixed tubular member, that is fixedly mountable using a pair of mounting brackets 72 (only one shown) at both ends of shade 60. Mounting brackets 72 are configured to be mounted proximate a window such as the inner side walls of a window aperture 86 with e.g., a screw 88. Contained within fixed tubular member 63 is a reversible motor 64, control circuit 66 and a mechanical linkage 73. Mechanical linkage 73 may comprise any system for effectuating rotation of rotatable tubular member 62 relative to fixed tubular member 63. In this example, gears are utilized to drive the rotatable tubular member 62. In another embodiment, a shaft extending from the motor out of the fixed tubular member 63 may be keyed into the rotatable tubular member 62 to effectuate rotation. Note that while the present embodiments are described using tubular members, any alternative structures suitable to achieves the desired results could be substituted therefor.

A collar assembly 74 may be employed at each end of the shade 60 (only one shown) to fixedly separate rotatable tubular member 62 from fixed tubular member 63. In this example, collar assembly 74 may be utilized to impart a friction component that resists movement of the rotatable tubular member 62. A designed amount of friction can be imparted to ensure creeping of the shade 60 does not occur in the hold state, while allowing the shade 60 to deploy and stow relatively freely. With this configuration, each side edge of shade material 64 and ends of rotatable tubular member 62 can be mounted extremely close to an adjacent window aperture 86 on each side, e.g., 0.1-0.25 inches or less.

Reversible motor 64 is controlled and powered via a set of motor leads 84 that are coupled to control circuit 66. Control circuit 66 may comprise any of the circuits described herein or any equivalent circuits known in the art. Further coupled to control circuit 66 are lead wires 80, 82 that are linked to a power source 68 and a set of momentary (up/down) switches 70, respectively, that together form an actuation system. When the up or down switch is depressed, control circuit 66 causes the motor 64 to drive mechanical linkage 73, which then rotates the rotatable tubular member 62 in the direction selected. As noted above, control circuit 66 can switch reversible motor 64 among at least three operational states, including: a hold state in which the motor leads 84 are shorted to resist rotation, a deploy state in which the motor leads 84 are connected to power source 68 to deploy shade material 64, and a stow state in which motor leads 84 are connected in reverse to the power source 68 to stow the shade material 64.

Resistance associated with the reversible motor 64 in the hold state along with the friction component associated with the functional elements in window shade 60 (e.g., collar assembly 74 and rotatable tubular member 63) creates a combined drag to resist a gravitational load from the deployed shade material 64, which would otherwise change an amount of deployment. In other words, the described braking system ensures that the deployed shade material 64 remains stationary when in the hold state.

In this illustrative embodiment, lead wires 80, 82 are fed through one of the mounting brackets 72 to provide external access for power source 68 and switches 70. Lead wires 80, 82 may be implemented with flat cables to minimize interference with shade 60. Moreover, lead wires 80, 82 may include adhesive to maintain them in place along the window's edge or trim. Lead wires 80, 82 may also run within the gap 90 between the shade material 64 and the window surround, and may be cut to length for onsite assembly. Lead wires 80, 82 may also be bundled in part and stowed out of sight behind a head rail (not shown) to obtain a desired length between the head rail and switches 70, during onsite assembly. Accordingly, switches 70 and power source 68 can be readily mounted anywhere along the window edge (or its trim). To further reduce the impact, switches 70 may be implemented with momentary contacts that are less than about 0.1 inch thick.

In alternative embodiments, power source 68 and/or switches 70 could be completely or partially incorporated into the shade 60 itself. For instance, in one alternative embodiment, a battery could be incorporated into mounting bracket 72 or into fixed tubular member 63. In a further alternative embodiment, switches 70 could be incorporated into mounting bracket 72 or into fixed tubular member 63 and be controllable by a wireless signal.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

In addition, although described with reference to a roller-type shade, the systems described herein could be implemented with any deployable window covering solution in which a braking system is desired to hold a shade material in place.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An actuation system for a window shade comprising:
a reversible motor mounted to a fixed member of the window shade, wherein the reversible motor includes a mechanism for driving a rotatable member of the window shade such that rotation of the reversible motor in a first direction deploys a shade material and rotation of the reversible motor in a second direction stows the shade material; and
a control circuit coupled to a set of motor leads of the reversible motor, wherein the control circuit switches the reversible motor among at least three operational states, including: a hold state in which the motor leads are shorted to resist rotation, a deploy state in which the motor leads are connected to a power source to deploy the shade material, and a stow state in which the motor leads are connected in reverse to the power source to stow the shade material.

2. The actuation system according to claim 1, wherein the rotatable member comprises a rotatable tubular member around which the shade material is stowed.

3. The actuation system according to claim 2, wherein the reversible motor is mounted within the rotatable tubular member.

4. The actuation system according to claim 1, wherein a resistance associated with the reversible motor in the hold state and a friction component associated with the rotatable member maintains the shade material in a fixed position.

5. The actuation system according to claim 3, further comprising:
a momentary switch for controlling the operational states; and
at least one connecting wire between the reversible motor and the momentary switch, wherein the momentary switch is located outside the rotatable tubular member.

6. The actuation system according to claim 5, wherein the connecting wire includes a flat cable.

7. The actuation system according to claim 5, wherein the control circuit further comprises a relay that responds to a switch state of the momentary switch to effect the operational state.

8. A window shade, comprising:
a fixed member;
a rotatable member that is rotatable relative to the fixed member;
a reversible motor mounted to the fixed member, wherein the reversible motor includes a mechanism for driving the rotatable member such that rotation of the reversible motor in a first direction deploys a shade material and rotation of the reversible motor in a second direction stows the shade material; and
a control circuit coupled to a set of motor leads of the reversible motor, wherein the control circuit switches the reversible motor among at least three operational states, including: a hold state in which the motor leads are shorted to resist rotation, a deploy state in which the motor leads are connected to a power source to deploy the shade material, and a stow state in which the motor leads are connected in reverse to the power source to stow the shade material.

9. The window shade according to claim 8, wherein the rotatable member comprises a rotatable tubular member around which the shade material is stowed.

10. The window shade according to claim 9, wherein the reversible motor is mounted within the rotatable tubular member.

11. The window shade according to claim 8, wherein a resistance associated with the reversible motor in the hold state and a friction component associated with the rotatable member maintains the shade material in a fixed position.

12. The window shade according to claim 10, wherein an edge of the shade material and the rotatable tubular member are mountable in less than 0.25 inches of a surrounding window aperture on each side.

13. The window shade according to claim 11, further comprising:
a momentary switch for controlling the operational states of the reversible motor; and
at least one connecting wire between the reversible motor and the momentary switch.

14. The window shade according to claim 13, wherein the connecting wire includes a flat cable.

15. The window shade according to claim 13, further comprising a relay that responds to a switch state of the momentary switch to select the operational state of the reversible motor.

16. The window shade according to claim 15, wherein the relay is located proximate the reversible motor within the rotatable tubular member.

17. A window shade, comprising:
a shade material; and
an actuation system for causing a motor to move the shade material in response to an activation of a momentary switch, wherein the actuation system includes a braking system that holds the shade material in place in response to a deactivation of the momentary switch, wherein the braking system short-circuits the motor to place the motor in a hold position state.

18. The window shade according to claim 17, wherein the braking system further includes a friction component associated with at least one moving part of the window shade.

19. The window shade according to claim 17, further comprising a double-pole, double-throw relay coupled to a first and a second momentary switch that short-circuits a pair of motor leads in response to the two momentary switches being deactivated.

20. The window shade according to claim 17, wherein activation of the momentary switch relieves the short-circuit and connects the motor to a voltage source.
